(19) United States
(12) Patent Application Publication
(10) Pub. No.: US 2007/0226418 A1
(43) Pub. Date: Sep. 27, 2007

(54) Processor and method for controlling processor

(75) Inventors: Yoshitaka Mizuno, Kawasaki (JP); Yoshihiro Hiji, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/499,811

(22) Filed: Aug. 7, 2006

(30) Foreign Application Priority Data
Mar. 24, 2006 (JP) 2006-082741

(51) Int. Cl. G06F 12/00; G06F 13/00

(52) U.S. Cl. 711/118; 711/135

(57) ABSTRACT

A processor judges, by a comparator, match between an address determined to be a breakpoint of the CPU core and an address of a data cache at which the CPU core accesses the data cache. The data cache outputs a cache hit signal indicating a result of detection of a cache hit/miss at the time of the access. Further, an AND circuit outputs a data break signal to the CPU core, based on a match judgment signal from the comparator and the cache hit signal from the data cache, and causes the CPU core to execute a break.

### CROSS-REFERENCE TO RELATED APPLICATIONS

This application is based upon and claims the benefit of priority from the prior Japanese Patent Application No. 2006-082741, filed on Mar. 24, 2006, the entire contents of which are incorporated herein by reference.

### BACKGROUND OF THE INVENTION

1. Field of the Invention

The present invention relates to a processor that controls a hardware break and a method of controlling the processor.

2. Description of the Related Art

Conventionally, a processor is equipped with debugging functions to monitor access to a specified data-address area and to break the processor when a result of comparison of monitored data address hits a predetermined condition, after completion of all instructions under execution.

As an example of the debugging functions, a processor that provides a trap function to generate a trap interruption according to a value of trap bits has been disclosed in, for example, Japanese Patent Laid-Open Publication No. H4-350735. In the above processor, at least one of an instruction cache and a data cache in the processor is configured to include a tag memory area having trap bits for registering a trap interrupt request synchronizing with a replacement bus cycle at the time of a cache mishit.

As another example of the debugging functions, a processor in which whether an instruction or data to be debugged exists in a cache memory is easily recognized has been disclosed in, for example, Japanese Paten Laid-Open Publication No. H5-204709. The processor includes a bit register that indicates whether the instruction or the data exists in the cache or in a memory at the time of occurrence of an instruction or data break.

However, in cases when a core other than a central processing unit (CPU) core, such as a direct memory access (DMA) core, directly accesses the main memory, or when more than one core, for example, a CPU and a DMA, in a multiprocessor performs a processing in which the same memory area is accessed, disagreement in contents between the main memory and the cache memory, i.e., mismatch of the memory area, can occur.

FIG. 1 is a schematic for illustrating mismatch of the memory area caused when more than one core accesses the same memory area. As shown in FIG. 1, a CPU core 600 realizes read out and write in with high speed by accessing a data cache 601 (or an instruction cache in which instructions are held) instead of accessing a main memory 602.

On the other hand, a DMA core 603 directly accesses the main memory 602 to rewrite data. The content of the data cache 601 remains the same as the previous content of a memory area 604 in the main memory 602. Therefore, when the CPU core 600 accesses the data cache 601 and only performs reading-out, the content in the data cache 601 and that in the memory area 604 are maintained consistent. However, when writing-in is performed on the data cache 601, a mismatch within the data area occurs due to the disagreement between the content retained in the data cache 601 and the content in the memory area 604.

As a means to solve the above mismatch within the data areas, a bus snoop mechanism can be considered. The bus snoop mechanism is a function to notify disagreement to the CPU core and to recover the match between the main memory and the cache. However, if such bus snoop mechanism is installed, manufacturing cost increase as a circuit becomes complicated. In addition, an inspection operation becomes complicated.

Therefore, in a small-scale processor for embedded application, a technique to guarantee the match between the main memory and the cache memory by software has been provided, without mounting the bus snoop mechanism. The technique guaranteed by such software also has a problem. When the contents in the main memory and the cache memory become mismatched and cause a malfunction in an operation of the software, analysis of the cause is difficult.

When analyzing the mismatch, a data breakpoint is usually set to the address where mismatch is suspected, and presence of the mismatch is checked while temporarily stopping execution of program when the address is accessed.

However, in the cases when the address suspected of mismatch is the locus of a variable referred to from various points of the program or of the variable referred to in a loop executed for enormous numbers of times, halts of the CPU core by the data break executions occurs repeatedly, and the checking each time becomes a heavy work requiring extensive time and effort. In other words, the breaks are performed frequently even on the condition where it is not necessary for the CPU core to perform the breaks. As a result, the processing speed of the processor is deteriorated.

### SUMMARY OF THE INVENTION

It is an object of the present invention to solve at least the above problems in the conventional technologies.

A processor according to one aspect of the present invention includes a judging unit configured to judge match between an address determined as a breakpoint of a central-processing-unit (CPU) core and an address of a cache at which the CPU core accesses the cache; a cache hit/miss detecting unit configured to detect a cache hit/miss occurred at time of access by the CPU core; and a generating unit configured to generate, based on a result of judgment by the address judgment unit and a detected cache hit/miss, a break signal to cause a break execution to the CPU core.

A method according to another aspect of the present invention is of controlling a processor, and includes judging match between an address determined as a breakpoint of a CPU core and an address of a cache at which the CPU core accesses the cache; detecting a cache hit/miss occurred at time of access by the CPU core; and generating, based on a result of judgment at the judging and a detected cache hit/miss, a break signal to cause a break execution to the CPU core.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic for illustrating mismatch caused when more than one core accesses an identical memory area;

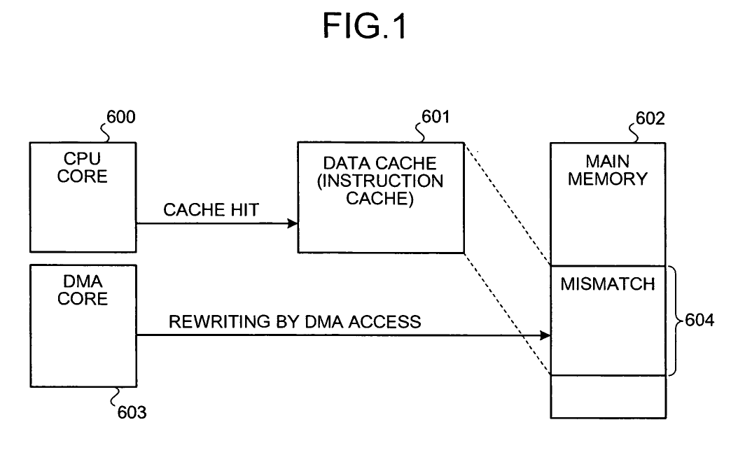

FIG. 2 is a schematic of a circuit configuration of a processor according to a first embodiment of the present invention;

FIG. 3 is a schematic of a circuit configuration of a processor according to a second embodiment of the present invention;

FIG. 4 is a schematic of a circuit configuration of a processor according to a third embodiment of the present invention;

FIG. 5 is a schematic for illustrating transition of states of a data cache in a copy back mode; and

FIG. 6 is a schematic for illustrating a relation between an operation of a CPU core and contents of a main memory in the copy back mode.

### DETAILED DESCRIPTION OF THE PREFERRED EMBODIMENTS

Exemplary embodiments of the present invention will be explained in detail with reference to the accompanying drawings.

A processor explained in a first embodiment controls a CPU core to execute a data break at the time of occurrence of cache hit/miss. Moreover, it has a function to set a condition to execute the data break in detail. The condition to execute the data break may be detection of a data break address, occurrence of a cache hit/miss, etc.

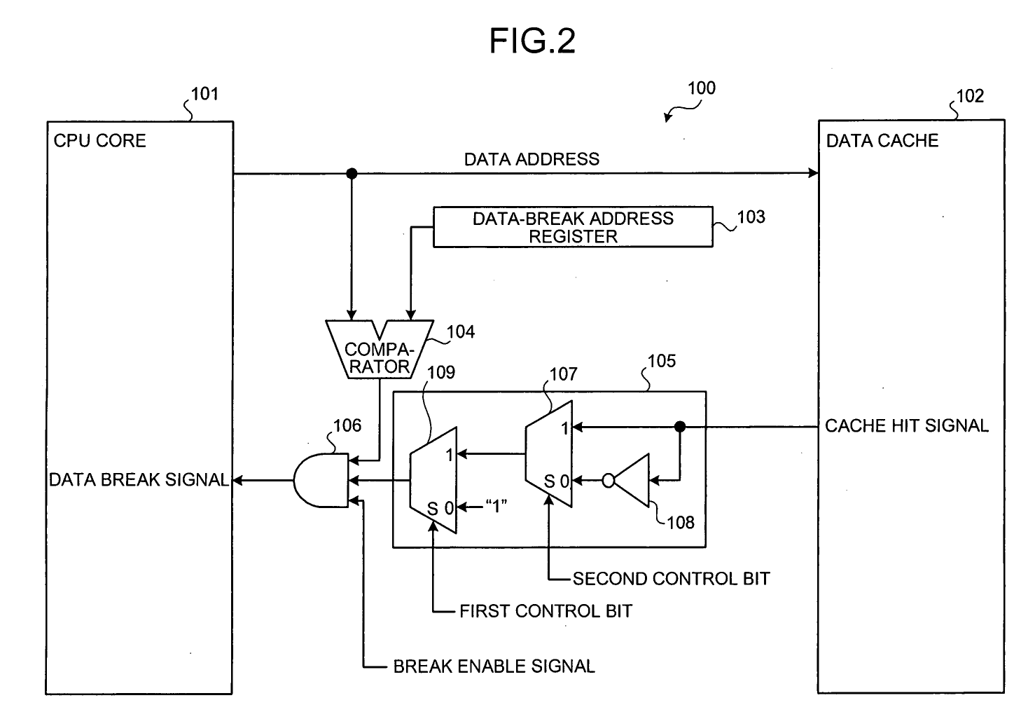

FIG. 2 illustrates a circuit configuration of the processor according to the first embodiment. As shown in FIG. 2, a processor 100 includes a CPU core 101, a data cache 102, a data-break address register 103, a comparator 104, a condition setting circuit 105, and an AND circuit 106.

The CPU core 101 accesses a predetermined data address in the data cache 102 according to a program currently being executed, and reads out the data. At the same time as this access to the data cache 102, the CPU core 101 outputs information on the data address of the access destination to the comparator 104.

A data break signal (binary 0 or 1) is also input into the CPU core 101 from the AND circuit 106. The CPU core 101 executes the data break when a data break signal “1” is input as an instruction to execute data break. On the other hand, when the data break signal “0” is input into the CPU core 101 from the AND circuit 106, the CPU core 101 continues processing according to the program currently being executed.

In the data cache 102, data frequently read out are stored such that the data can be read out at high speed. Each data in the data cache 102 is stored corresponding to each data address. Therefore, the CPU core 101 can read out desired data by specifying the data address to access the data cache 102.

The data cache 102 also outputs, to the condition setting circuit 105, a cache hit signal (binary 0 or 1) indicating whether the data read out is succeeded at the access of the CPU core 101. Specifically, for example, the case when CPU core 101 could read out desired data from the accessed data address, is referred to as “cache hit”, and the case when the CPU core 101 could not read out desired data from the accessed data address, in other words, when the data is not stored at the data address, is referred to as “cache miss”.

According to the above described processing, the data cache 102 outputs the cache hit signal “1”, when “cache hit” is achieved at the access. On the other hand, the data cache 102 outputs the cache hit signal “0”, when the access ends in “cache miss”. In case of “cache miss”, the CPU core 101 accesses a main memory not shown, and reads out the desired data.

In a data-break address register 103, information on the data address used as a breakpoint is written. A breakpoint is a code to perform a compulsory execution stop provided in order to conduct an operation check of the program. Information on the data address used as the breakpoint is input into the comparator 104. Meanwhile, the information on the data address may be written in the data-break address register 103 by a higher order program, or may be individually written by a user.

The comparator 104 compares the data address input from the CPU core 101 with the data address used as the breakpoint input from the data-break address register 103, and outputs a match judgment signal (binary 0 or 1).

For example, the comparator 104 outputs the match judgment signal “1” indicating match, to the AND circuit 106, only when the contents to be compared, i.e., the data address to which the CPU core 101 is accessing and the breakpoint address, are in agreement. The comparator 104 and outputs the match judgment signal “0” indicating mismatch when the data address to which the CPU core 101 is accessing and the breakpoint address are not in agreement.

The condition setting circuit 105 outputs a generation condition signal (binary 0 or 1) of the data break to the AND circuit 106, according to the cache hit signal input from the data cache 102. This condition setting circuit 105 includes selector circuits 107 and 109, and a NOT circuit 108.

The selector circuit 107 or 109 is output the signal input into the input terminal with the number indicated by the signal input into the selector terminal S, without any change. For example, when signals are input into the input terminal 0 and 1, respectively, if a signal indicating “0” is input into the selector terminal S, the selector circuit 107 or 109 outputs the signal input into the input terminal 0 without any change.

The condition setting circuit 105 can designate, by individually applying settings to the selector circuits 107 and 109, whether detection of a cache hit/miss is to be the condition for execution of data break, and further, which one of the cache hit and the cash miss is to be the condition.

Into the AND circuit 106, the match judgment signal from the comparator 104, the break execution permission signal from the condition setting circuit 105, and a break enable signal are input, and the AND circuit 106 outputs a data break signal to the CPU core 101 based on the input signals.

For example, the AND circuit 106 outputs the data break signal “1” to the CPU core 101, only when all the input signals are “1”. Therefore, if even one of the input signals is “0”, the AND circuit 106 outputs the data break signal “0”.

As described above, the processor 100 can set a condition to execute the data break. The specific setup is performed using the condition setting circuit 105 and the AND circuit 106.

First, the setting in the condition setting circuit 105 is performed by the selector circuits 107 and 109. Into the selector terminal S of the selector circuit 109, a first control bit (binary 0 or 1) is input. According to the value of the first control bit, whether the cache hit/miss in the data cache 102 is set to be a condition of data break execution can be specified.

For example, when the cache hit/miss in the data cache 102 is set to be the condition, “1” is input into the selector terminal S of the selector circuit 109 as the first control bit. In contrast, when the cache hit/miss in the data cache 102 is not set to be the condition, “0” is input into the selector terminal S of the selector circuit 109 as the first control bit.

Moreover, into the selector terminal S of the selector circuit 107, a second control bit (binary 0 or 1) is input that specifies which one of the “cache hit” and the “cache miss” is set to the condition.

For example, when the “cache hit” is set the condition, “1” is input into the selector terminal S of the selector circuit 107 as the second control bit. In contrast, when the “cache miss” is set to be the condition, “0” is input into the selector terminal S of the selector circuit 107 as the second control bit.

Moreover, the setting in the AND circuit 106 is performed by a break enable signal. The break enable signal specifies whether execution of data break by the CPU core 101 is permitted or forbidden.

For example, when data break execution of the CPU core 101 is to be permitted, a break enable signal “1” is input into the AND circuit 106. On the other hand, when the data break execution of the CPU core 101 is to be forbidden, a break enable signal “0” is input into the AND circuit 106.

By performing each of the above described setups, the data break execution can be controlled as is explained below.

### <When the First Control Bit=0>

In this case, into the selector terminal S of the selector circuit 109, “0” is input as the first control bit, so that the selector circuit 109 outputs the break execution permission signal “1” irrespective of the value of the signal (binary 0 or 1) input from the selector circuit 107. Therefore, irrespective of the cache hit/miss of the data cache 102, the CPU core 101 can execute the data break, on condition of match of the data addresses.

### <When the First Control Bit=1 and the Second Control Bit=0>

In this case, into the selector terminal S of the selector circuit 107, “0” is input as the second control bit. If “0” indicating a cache miss is output as the cache hit signal from the data cache 102, “0” is input into the input terminal 1 of the selector circuit 107 and “1” reversed by the NOT circuit 108 is input into the input terminal 0. Then the selector circuit 107 outputs an output signal (binary 0 or 1) “1”.

Into the selector terminal S of the selector circuit 109, “1” is input as the first control bit, and “1” is input into the input terminal 1 from the selector circuit 107, so that the selector circuit 109 outputs the break execution permission signal “1”. Therefore, the CPU core 101 can execute the data break, on conditions of the “cache miss” of the data cache 102 and match of data addresses.

### <When the First Control Bit=1 and the Second Control Bit=1>

In this case, into the selector terminal S of the selector circuit 107, “1” is input as the second control bit. If “1” expressing a cache hit is output as a cache hit signal from the data cache 102, “1” is input into the input terminal 1 of the selector circuit 107. In contrast, into the input terminal 0, “0” reversed by the NOT circuit 108 is input. Accordingly, the selector circuit 107 outputs the output signal “1”.

Into the selector terminal S of the selector circuit 109, “1” is input as the first control bit, and into the input terminal 1, “1” is input from the selector circuit 107, so that the selector circuit 109 outputs the break execution permission signal “1”. Therefore, a data break can be executed by the CPU core 101 on condition of the “cache hit” of the data cache 102 and match of data addresses.

Meanwhile, the first control bit and the second control bit input into the condition setting circuit 105 and the break enable signal input into the AND circuit 106 use the values set beforehand in registers not shown. The settings on the resisters may be automatically done by a higher order program, or individually by a user.

As explained above, the processor according to the first embodiment can individually set the conditions for data break execution by the CPU core 101, using control bits and a break enable signal.

A processor according to a second embodiment of the present invention controls the CPU core to execute an instruction break at the time of cache hit/miss occurrence. Moreover, it has a function to set up in detail on what conditions, such as on detection of the data break address or on a cache hit/miss occurrence, the data break is executed.

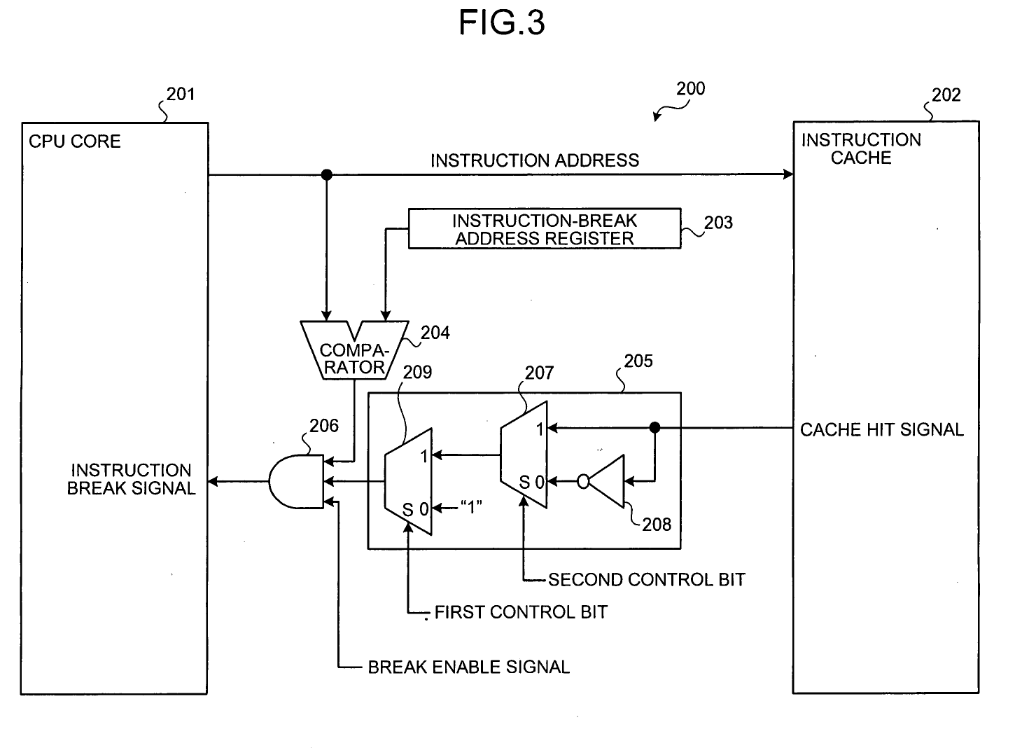

FIG. 3 illustrates a circuit configuration of the processor according to the second embodiment. As shown in FIG. 3, a processor 200 includes a CPU core 201, an instruction cache 202, an instruction break address register 203, a comparator 204, a condition setting circuit 205, and an AND circuit 206.

The CPU core 201 accesses the predetermined instruction address in the instruction cache 202 according to the program currently executed, and reads out instructions. At the same time as this access to the instruction cache 202, the CPU core 201 outputs, to the comparator 204, the information on the instruction address of the access destination.

An instruction break signal (binary of 0 or 1) is also input into the CPU core 201 from the AND circuit 206. The CPU core 201 executes an instruction break when the instruction break signal “1” is input as an instruction break execution instruction. On the other hand, when the instruction break signal “0” is input into the CPU core 201 from the AND circuit 206, The CPU core 202 continues the processing according to the program currently being executed without any change.

In the instruction cache 202, instructions frequently read out by the CPU core 202 are stored such that the instructions can be read out at high speed. Each instruction in the instruction cache 202 is stored corresponding to each data address. Therefore, the CPU core 201 can read out a desired instruction by specifying the instruction address to access the instruction cache 202.

Similarly to the data cache 102 in the first embodiment, the instruction cache 202 outputs, to the condition setting circuit 205, a cache hit signal (binary 0 or 1) indicating whether the data read out is succeeded at the access. Similarly, in the case of the “cache miss”, the CPU core 201 accesses a main memory not shown, and reads out the desired instructions.

In the instruction break address register 203, information on the instruction address used as a breakpoint is written, and the information on the instruction address used as breakpoint is input into the comparator 104. Meanwhile, the information on the instruction address may be written in the instruction break address register 203 by a higher order program, or may be individually written in by a user.

The comparator 204 compares the instruction address input from the CPU core 201 with the instruction address used as the breakpoint input from the instruction break address register 203, and outputs a match judgment signal.

The condition setting circuit 205 outputs a break execution permission signal of the instruction break to the AND circuit 206, according to the cache hit signal input from the instruction cache 202. This condition setting circuit 205 is constituted, including selector circuits 207 and 209, and a NOT circuit 208. Since the functions of the selector circuits 207, 209 and the NOT circuit 208 are the same as those of the selector circuits 107, 109 and the NOT circuit 108 of the first embodiment, explanation is omitted.

The condition setting circuit 205 can designate, by individually applying settings to the selector circuits 207 and 209, whether detection of a cache hit/miss by the instruction cache 202 is set as the condition for execution of instruction break, and further, which one of the cache hit and the cash miss is used as the condition of the instruction break execution.

Into the AND circuit 206, the match judgment signal from the comparator 204, the break execution permission signal from the condition setting circuit 205 and the break enable signal are input, and the AND circuit 206 outputs a instruction break signal to the CPU core 201 based on the input signals.

As described above, the processor 200 can set a condition to execute the instruction break. The specific setup is performed using the condition setting circuit 205 and the AND circuit 206.

First, the setup in the condition setting circuit 205 is performed by the selector circuits 207 and 209. Since the settings of the condition setting circuit for the instruction break execution in the condition setting circuit 205 are the same as those of the selector circuits 107 and 109 and the control bits in the setting by the condition setting circuit for the data break execution in the condition setting circuit 105 of the first embodiment, explanation is omitted.

Setting in the AND circuit 206 is performed by a break enable signal, in a similar manner as in the first embodiment. The break enable signal can specify whether instruction break execution by the CPU core 201 is permitted or forbidden.

Specifically, for example, when instruction break execution of the CPU core 201 is to be permitted, a break enable signal “1” is input into the AND circuit 206. On the other hand, when instruction break execution of the CPU core 201 is forbidden, a break enable signal “0” is input into the AND circuit 206.

By performing each of the settings, instruction break execution can be controlled as follows.

### <When the First Control Bit=0>

In this case, into the selector terminal S of the selector circuit 209, “0” is input as the first control bit, so that the selector circuit 209 outputs the break execution permission signal “1” irrespective of the value of the signal input from the selector circuit 207. Therefore, the CPU core 201 can execute an instruction break, on condition of match of the instruction addresses, irrespective of the cache hit/miss of the instruction cache 202.

### <When the First Control Bit=1 and the Second Control Bit=0>

In this case, into the selector terminal S of the selector circuit 207, “0” is input as the second control bit. Here, if “0” expressing a cache miss is output as the cache hit signal from the instruction cache 202, “0” is input into the input terminal 1 of the selector circuit 207 and “1” reversed by the NOT circuit 208 is input into the input terminal 0. Then the selector circuit 207 outputs an output signal “1”.

Into the selector terminal S of the selector circuit 209, “1” is input as the first control bit and “1” is input into the input terminal 1 from the selector circuit 207, so that the selector circuit 209 outputs the break execution permission signal “1”. Therefore, an instruction break can be executed by the CPU core 201 on condition of the “cache miss” of an instruction cache 202 and match of data addresses.

### <When the First Control Bit=1 and the Second Control Bit=1>

In this case, into the selector terminal S of the selector circuit 207, “1” is input as the second control bit. If “1” indicating a cache hit is output as a cache hit-signal from the instruction cache 202, “1” is input into the input terminal 1 of the selector circuit 207. In contrast, into the input terminal 0, “0” reversed by the NOT circuit 208 is input. Accordingly, the selector circuit 207 outputs the output signal “1”.

Into the selector terminal S of the selector circuit 209, “1” is input as the first control bit, and into the input terminal 1, “1” is input from the selector circuit 207, so that the selector circuit 209 outputs the break execution permission signal “1”. Therefore, an instruction break can be executed by the CPU core 201 on condition of the “cache hit” of an instruction cache 202 and match of data addresses.

Meanwhile, the first control bit and the second control bit input into the condition setting circuit 205 and the break enable signal input into the AND circuit 206 use the values set beforehand in registers not shown. The values may automatically be set by a higher order program, or may individually be set by a user.

As explained above, the processor 200 according to the second embodiment can individually set the conditions for data break execution by the CPU core 201, using control bits and a break enable signal.

In a processor explained in a third embodiment of the present invention, the CPU core accesses the data cache having a copy back mode. Also in such a processor, the CPU core is caused to execute a data break at the time of cache hit/miss occurrence. Moreover, the processor has a function of setting conditions in detail for execution of the instruction break. The conditions include detection of the data break address, occurrence of a cache hit/miss, a line state of the data cache peculiar to the copy back mode, etc.

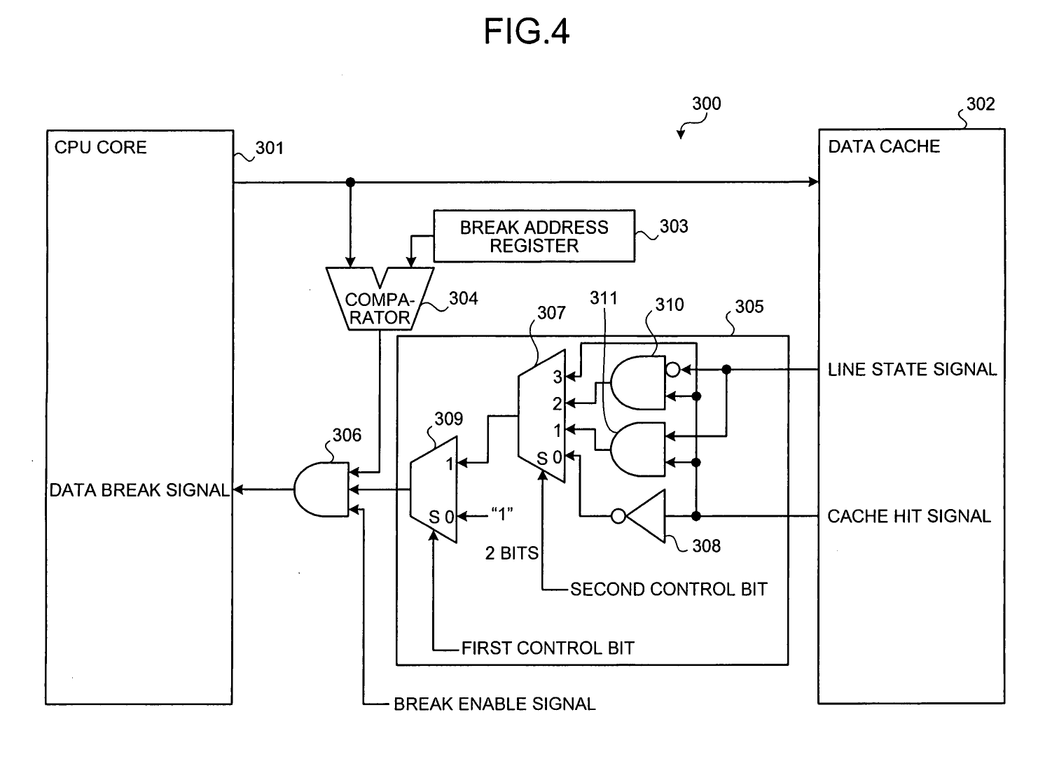

FIG. 4 illustrates a circuit configuration of the processor according to the third embodiment. As shown in FIG. 4, the processor 300 includes a CPU core 301, a data cache 302, a break address register 303, a comparator 304, a condition setting circuit 305, and an AND circuit 306.

Among the above configuration, the CPU core 301, the break address register 303, the comparator 304 and the AND circuit 306 have the same functions as the CPU core 101, the data-break address register 103, the comparator 104 and the AND circuit 106 of the processor 100 of the first embodiment (see FIG. 2), respectively. Therefore, explanation therefor is omitted.

In the data cache 302, similarly to the data cache 102 of the first embodiment, data read out at high frequency by the CPU core 301 are stored, such that the data can be read out at high speed. Also, each data of the data cache 302 is stored corresponding to each data address.

The data cache 302 operates in the copy back mode. In the copy back mode, when the data cache 302 is rewritten by an access of the CPU core 301, rewritten contents are not reflected to the main memory until the rewriting instruction is given. Since it is not necessary to rewrite the main memory upon every rewriting of the data cache 302, the processing speed can be improved.

As mentioned above, since the data cache 302 operates in the copy back mode, the data cache 302 outputs a line state signal (binary 0 or 1) indicating a line state of a data block in the data cache 302, in addition to the cache hit signal indicating the cache hit/miss of an access by the CPU core 301.

As the line states includes two states: a dirty (state) and a clean (state). Dirty indicates a state where each data stored in each data address has been rewritten by the access of the CPU core 301, while clean indicates a state where each data is not rewritten by the access of the CPU core 301, in other words, the content having been read out from the main memory is maintained unchanged.

The data cache 302 outputs the line state signal to the condition setting circuit 305, according to the line state. If the data cache 302 is clean, the data cache 302 outputs the line state signal “0”, and if the data cache 302 is dirty, the data cache 302 outputs the line state signal “1”.

The condition setting circuit 305 outputs a break execution permission signal of a data break to the AND circuit 306, based on the cache hit signal and the line state signal input from the data cache 302. This condition setting circuit 305 includes selector circuits 307 and 309, a NOT circuit 308, and AND circuits 310 and 311.

The selector circuit 309 performs the same operation as the selector circuit 109 of the first embodiment, but the selector circuit 307 has four input terminals (0 to 3), and so a two-bit binary second control bit indicating 0 to 3 is input into a selector terminal S.

For example, the second control bit input into the selector terminal S is of four kinds: “00=0”, “01=1”, “10=2”, and “11=3”. The selector circuit 307 outputs the signal input into the input terminal with the number specified by the second control bit without any change.

Furthermore, operation of AND circuits 310 and 311 are similar to the AND circuit 306, and the AND circuits 310 and 311 output “1”, only when all the input signals are fully, and the NOT circuit 308 reverses the input signal.

By making individual settings for the selector circuits 307 and 309, the condition setting circuit 305 can specify whether detection of the cache hit/miss of the data cache 302 is set to the condition of the data break execution; which state of the cache hit, in the dirty state or in the clean state, is set to the condition of the data break execution; or which of a cache hit and a cash miss is set to the condition of the data break execution, etc.

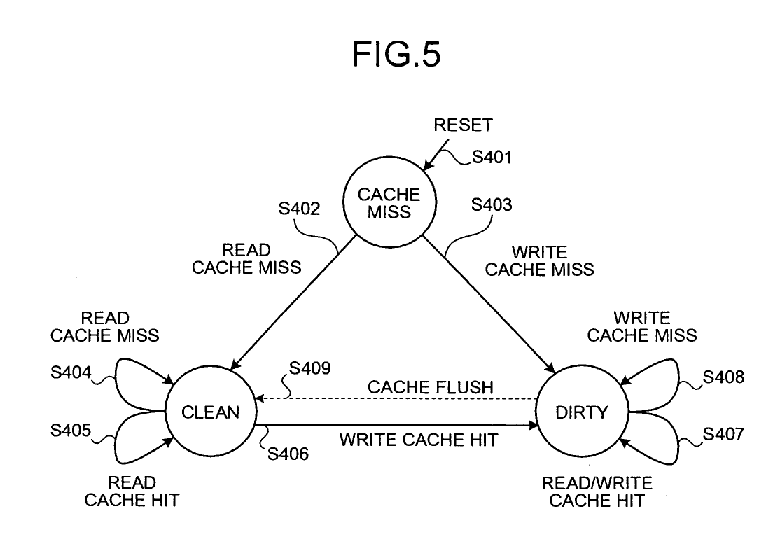

FIG. 5 illustrates transition of states of the data cache in the copy back mode. As shown in FIG. 5, a cache that performs copy back makes transitions among three states, “cache miss”, “clean”, and “dirty”, according to instructions from the CPU core. Although the data cache 302 is supposed to always achieve a data hit, in a practical operation, a cache miss occurs frequently and the data cache 302 makes transitions frequently among the three states shown in FIG. 5.

### <Transition from the Cache Miss State>

As shown in FIG. 5, a state of the data cache 302 becomes the cache miss state by being reset (S401). When a cache miss occurs in the cache miss state at data read by the CPU core 301 (S402), data read out from the main memory is written in the data cache 302. Thus, a state of the data cache 302 becomes the clean state because contents of the data cache 302 have been unchanged since new data had been taken in from the main memory.

When a cache miss occurs in the cache miss state at data write by the CPU core 301 (S403), new data is written in the data cache 302 from the CPU core 301. Therefore, a state of the data cache 302 becomes the dirty state because new data is written on the data that has been taken in from the main memory.

### <Transition from the Clean State>

When a cache miss occurs in the clean state (S404) at data read by the CPU core 301, data read out from the main memory is written in the data cache 302. The data cache 302 remains in the clean state, because new data is taken in from the main memory and remains unchanged.

When a cache hit occurs in the clean state at data read by the CPU core 301 (S405), the data retained in the data cache 302 is read out. The data cache 302 remains in the clean state, because contents of the data cache 302 have been unchanged since new data had been taken in from the main memory.

When a cache hit occurs in the clean state at data write by the CPU core 301 (S406), new data is written in the data cache 302 from the CPU core 301. Thus, a state of the data cache 302 becomes the dirty state because new data is written in on the data that has been taken in from the main memory.

### <Transition from the Dirty State>

When a cache hit occurs in the dirty state at data read/write by the CPU core 301 (S407), read out or write in is done on the data cache 302. However, since the data cache 302 is already in the dirty state, it remains in the dirty state irrespective of the read/write.

When a cache miss occurs in the dirty state at data write by the CPU core 301 (S408), new data is written in the data cache 302 from the CPU core 301. Since the data cache 302 has already been in the dirty state, even if the new data is written in this processing, the data cache 302 remains to be in the dirty state.

When a cache flush is performed by an exclusive instruction from the CPU core 301 on the data cache 302 in the dirty state (S409), the data cache 302 deletes the data currently stored at the specified data address after copying the data in the main memory. Therefore, a state of the data cache 302 becomes the clean state.

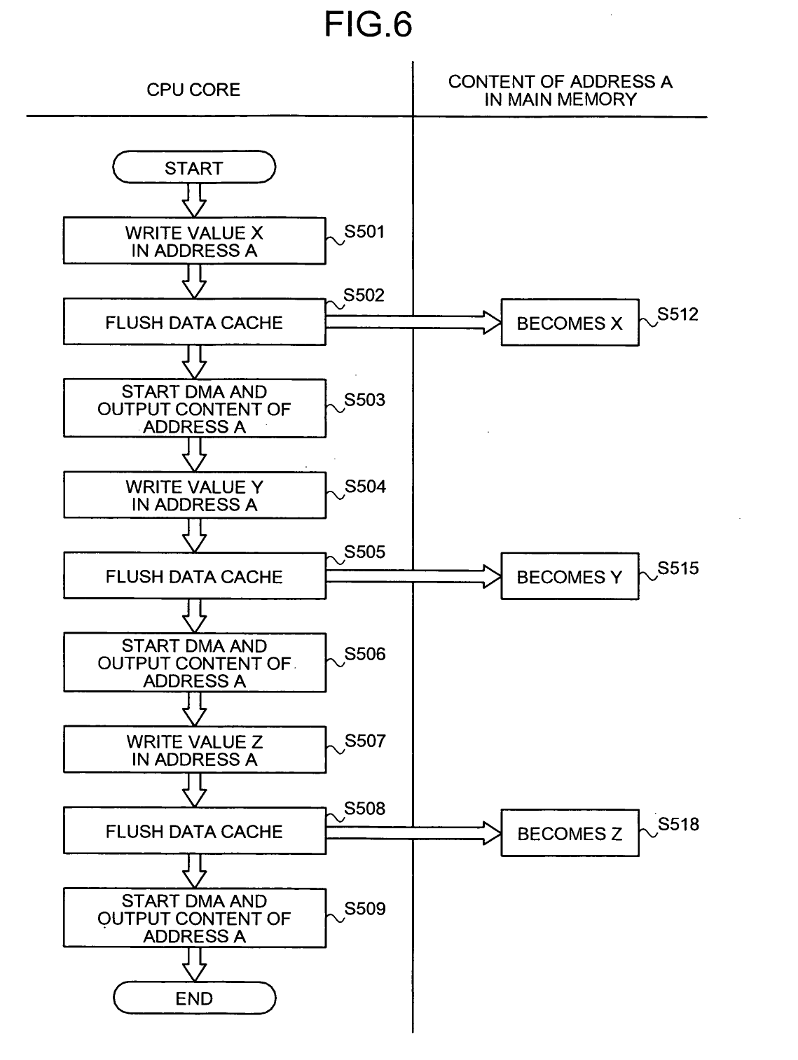

FIG. 6 illustrates a relation between an operation of the CPU core and contents of the main memory in the copy back mode. A left half in FIG. 6 illustrate the operation of the CPU core 301 in the processor 300, and a right half illustrates a data content at address A in the main memory corresponding to a data content stored at the data address (the address A) at which the CPU core 301 accesses the data cache 302 is stored.

For example, when the processor 300 writes values X to Z in the same data address (address A) in the data cache 302 and outputs the written content by an external core such as a DMA core, as shown in FIG. 6, first, the value X is written at address A (step S501). Then, the data cache 302 is flushed (step S502), and the DMA is started to output the content of the address A (step S503).

Subsequently, the value Y is written at address A (step S504), the data cache 302 is then flushed (step S505), and the DMA is started to output the content of the address A (step S506).

Finally, the value Z is written at address A (step S507), the data cache 302 is flushed (step S508), and the DMA started to output the content of Address A (step S509).

By the above described flush processing of the data cache 302 with the value X by the CPU core 301 (step S502), the retained content of the address A of the main memory becomes X (step S512); by the flush processing of the data cache 302 with the value Y (step S505), the retained content of the address A of the main memory becomes Y (step S515); and by the flush processing of the data cache 302 with the value Z (step S508), the retained content of address A of the main memory becomes Z (step S518).

In other words, the data cache 302 operates in the copy back mode. To correctly output the content written in by the CPU core 301, the content of the data cache 302 is required to be flushed and to be written in the main memory, before the external core such as DMA starts.

By promptly detecting the data hit occurred on the data cache 302 in the dirty state to execute the break, it is possible to flush the contents of the data cache 302 before the external core starts. Therefore, the processor 300 can set the data hit in the dirty state as the condition for break execution. Moreover, to make the analysis processing easy at the time when a mismatch between the data cache 302 and the main memory has occurred, not only the data hit in the dirty state but also the data hit in the clean state can be set as the condition for break execution.

As described above, the processor 300 can set the condition for execution of the data break. Specific settings are implemented by the condition setting circuit 305 and the AND circuit 306.

First, the setting in the condition setting circuit 305 is performed by the selector circuits 307 and 309. Into the selector terminal S of the selector circuit 309, the first control bit is input. According to the value of the first control bit, whether to set the cache hit/miss in the data cache 302 as the condition for data break execution can be specified.

For example, when the cache hit/miss in the data cache 302 is set to the condition, “1” is input into the selector terminal S of the selector circuit 309 as the first control bit. On the other hand, when the cache hit/miss in the data cache 302 is not set to the condition, “0” is input into the selector terminal S of the selector circuit 309 as the first control bit.

Into the selector terminal S of the selector circuit 307, the 2 bit second control bit is input, and the following conditions for execution of the data break can be set:

“Cache hit” in the data cache 302 (the second control bit=11)

“Cache miss” in the data cache 302 (the second control bit=00)

“Cache hit” when the line state is dirty (the second control bit=01)

“Cache hit” when the line state is clean (the second control bit=10)

For example, when the “cache hit” in the data cache 302 is set to the condition, “11” is input into the selector terminal S of the selector circuit 307 as the second control bit. On the other hand, when the “cache miss” in the data cache 302 is set to the condition, “00” is input into the selector terminal S of the selector circuit 307 as the second control bit.

Furthermore, when the line state is dirty and the “cache hit” is set to the condition for the data break execution, “01” is input into the selector terminal S of the selector circuit 307 as the second control bit, and when the line state is clean and the “cache hit” is set to the condition, “10” is input into the selector terminal S of the selector circuit 307 as the second control bit, Moreover, the settings in the AND circuit 306 is performed by the break enable signal. The break enable signal can set whether the data break execution by the CPU core 301 is permitted or forbidden.

For example, when the data break execution is permitted, the break enable signal “1” is input into the AND circuit 306. On the other hand, when data break execution is forbidden, the break enable signal “0” is input into the AND circuit 306.

By performing each of the above described settings, the data break execution can be controlled as explained below.

### <When the First Control Bit=0>

In this case, into the selector terminal S of the selector circuit 309, “0” is input as the first control bit, so that the selector circuit 309 outputs the break execution permission signal “1” irrespective of the value of the signal input from the selector circuit 307. Therefore, irrespective of the cache hit/miss of the data cache 302, the CPU core 301 can execute the data break on condition of match of the data addresses.

### <When the First Control Bit=1 and the Second Control Bit=00>

In this case, into the selector terminal S of the selector circuit 307, “00” is input as the second control bit. If “0” indicating the cache miss is output as the cache hit signal from the data cache 302, “0” is input into the input terminal 3 of the selector circuit 307, into the AND circuits 310 and 311, and into the NOT circuit 308.

As described above, the second control bit “00” is input into the selector circuit 307, so that the selector circuit 307 outputs the signal input into the input terminal 0. Since the inversed signal of the input signal to the NOT circuit 308 is input into the input terminal 0, the selector circuit 307 outputs “1” to the selector circuit 309.

Into the selector terminal S of the selector circuit 309, “1” is input as the first control bit, and “1” is input into the input terminal 1 from the selector circuit 307, so that the selector circuit 309 outputs break execution permission signal “1”. Therefore, irrespective of the line state, the data break can be executed by the CPU core 301 on condition of the “cache miss” of the data cache 302 and match of data addresses.

### <When the First Control Bit=1 and the Second Control Bit=01>

In this case, into the selector terminal S of the selector circuit 307, “01” is input as the second control bit. If “1” indicating the cache hit is output as the cache hit signal from the data cache 302, “1” is input into the input terminal 3 of the selector circuit 307, into the AND circuits 310 and 311, and into the NOT circuit 308.

Furthermore, if the line condition signal “1” indicating the dirty is output from the data cache 302, “1” is input into the AND circuit 311, and the reversed “0” is input into the AND circuit 310. As described above, the second control bit “01” is input into the selector circuit 307, so that the selector circuit 307 outputs the signal input into the input terminal 1. In the input terminal 1, the signal output from the AND circuit 311 is input. The AND circuit 311 outputs “1” since the cache hit signal “1” and the line state signal “1” are input. Therefore, “1” is input into the selector circuit 309.

Into the selector terminal S of the selector circuit 309, “1” is input as the first control bit, and “1” is input into the input terminal 1 from the selector circuit 307, so that the selector circuit 309 outputs the break execution permission signal “1”. Therefore, the data break can be executed by the CPU core 301 on condition of the “cache miss” of the data cache 302 with the dirty line state and of the match state of data addresses.

### <When the First Control Bit=1 and the Second Control Bit=10>

In this case, into the selector terminal S of the selector circuit 307, “10” is input as the second control bit. If “1” expressing the cache hit is output as the cache hit signal from the data cache 302, “1” is input into the input terminal 3 of the selector circuit 307, into the AND circuits 310 and 311, and into the NOT circuit 308.

If the line state signal “0” indicating clean is output from the data cache 302, “0” is input into the AND circuit 311 and the reversed “1” is input into the AND circuit 310. As described above, the selector circuit 307 outputs the signal input into the input terminal 2 since the second control bit “10” is input. Into the input terminal 2, the signal output from the AND circuit 310 is input. The AND circuit 310 outputs “1” since the cache hit signal “1” and the inverted signal “1” of the line state signal “0” are input. Therefore, “1” is input into the selector circuit 309.

Into the selector terminal S of the selector circuit 309, “1” is input as the first control bit, and into the input terminal 1, “1” is input from the selector circuit 307, then, the selector circuit 309 outputs the break execution permission signal “1”. Therefore, the data break can be executed by the CPU core 301 on condition of the “cache miss” of the data cache 302 with the clean line state and of the match state of data addresses.

### <When the First Control Bit=1 and the Second Control Bit=11>

In this case, into the selector terminal S of the selector circuit 307, “11” is input as the second control bit. Here, if “1” indicating the cache hit is output from the data cache 302 as the cache hit signal, “1” is input into the input terminal 3 of the selector circuit 307, into the AND circuits 310 and 311, and into the NOT circuit 308.

As described above, the selector circuit 307 outputs the signal input into the input terminal 3 because the second control bit “11” is input. Into the input terminal 3, the cache hit signal “1” is input directly from the data cache 302, so that the selector circuit 307 outputs “1” to the selector circuit 309.

Into the selector terminal S of the selector circuit 309, “1” is input as the first control bit, and into the input terminal 1, “1” is input from the selector circuit 307, then the selector circuit 309 outputs the break execution permission signal “1”. Therefore, irrespective of the line state, data break can be executed by the CPU core 301 on condition of the “cache hit” of the data cache 302 and match of data addresses.

The first control bit and the second control bit input into the condition setting circuit 305 and the break enable signal input into AND circuit 306 use values set in advance in a register not shown. The values may be automatically set by a higher order program, or individually set by a user.

As explained above, the processor 300 according to the third embodiment can individually set the conditions for the data break execution by the CPU core 301 using the line state signal in the copy back mode in addition to the control bits and the break enable signal.

As explained above, according to the processor and the method of controlling the processor, conditions for break execution can individually be set. Therefore, the analysis of the cause of mismatch of the memory area is easy, and the usual processing speed can be maintained except time corresponding to the set conditions for the break execution.

According to the embodiments described above, it is possible to facilitate an analysis of a cause of mismatch in a memory area, and to improve processing speed with a simple circuit configuration.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A processor comprising:
a judging unit configured to judge match between an address determined as a breakpoint of a central-processing-unit (CPU) core and an address of a cache at which the CPU core accesses the cache;
a cache hit/miss detecting unit configured to detect a cache hit/miss occurred at time of access by the CPU core; and
a generating unit configured to generate, based on a result of judgment by the address judgment unit and a detected cache hit/miss, a break signal to cause the CPU core to execute a break.

2. The processor according to claim 1, further comprising a setting unit configured to set a condition to cause the CPU core to execute the break, and to output a break permission signal for permitting the break to the generating unit, based on the condition and the detected cache hit/miss, wherein
the generating unit is configured to generate the break signal based on the result of judgment and the break permission signal.

3. The processor according to claim 2, further comprising a state detecting unit configured to detect a state of data in the cache, the data stored corresponding to each data address, wherein
the state detecting unit is configured to detect whether the state is a dirty state or a clean state, the dirty state in which the data has been rewritten by the CPU core at the time of the access, the clean state in which the data has not been rewritten, and
the setting unit is configured to output the break permission signal based on the state.

4. The processor according to claim 2, wherein
the condition includes detection of a cache hit by the cache hit/miss detecting unit, and
the setting unit is configured to output the break permission signal when the cache hit/miss detecting unit detects the cache hit, and not to output the break permission signal when the cache hit/miss detecting unit detects the cache miss.

5. The processor according to claim 2, wherein
the condition includes detection of a cache hit by the cache hit/miss detecting unit, and
the setting unit is configured to output the break permission signal when the cache hit/miss detecting unit detects the cache miss, and not to output the break permission signal when the cache hit/miss detecting unit detects the cache hit.

6. The processor according to claim 3, wherein
the condition includes detection of the dirty state, and
the setting unit is configured to output the break permission signal when the state detecting unit detects the dirty state, and not to output the break permission signal when the state detecting unit detects the clean state.

7. The processor according to claim 3, wherein
the condition includes detection of the clean state, and
the setting unit is configured to output the break permission signal when the state detecting unit detects the clean state, and not to output the break permission signal when the state detecting unit detects the dirty state.

8. The processor according to claim 2, wherein
the generating unit is configured to cause the CPU core to execute the break irrespective of the result of the judgment and presence or absence of the break permission signal, when a break enable signal indicating permission of execution of the break is input to the CPU core.

9. A method of controlling a processor, comprising:
judging match between an address determined as a breakpoint of a CPU core and an address of a cache at which the CPU core accesses the cache;
detecting a cache hit/miss occurred at time of access by the CPU core; and
generating, based on a result of judgment at the judging and a detected cache hit/miss, a break signal to cause the CPU core to execute a break.

10. The method according to claim 9, further comprising
setting a condition to cause the CPU core to execute the break; and
outputting a break permission signal for permitting the break, based on the condition and the detected cache hit/miss, wherein
the generating includes generating the break signal based on the result of judgment and the break permission signal.

11. The method according to claim 10, further comprising:
detecting a state of data in the cache, the data stored corresponding to each data address, wherein
the detecting a state includes detecting whether the state is a dirty state or a clean state, the dirty state in which the data has been rewritten by the CPU core at the time of the access, the clean state in which the data has not been rewritten, and
the outputting includes outputting the break permission signal based on the state.

12. The method according to claim 10, wherein
the condition includes detection of a cache hit at the detecting a cache hit/miss, and
the outputting includes outputting the break permission signal when the cache hit is detected, without outputting the break permission signal when the cache miss is detected.

13. The method according to claim 10, wherein
the condition includes detection of a cache hit at the detecting a cache hit/miss, and
the outputting includes outputting the break permission signal when the cache miss is detected, without outputting the break permission signal when the cache hit is detected.

14. The method according to claim 11, wherein
the condition includes detection of the dirty state, and
the outputting includes outputting the break permission signal when the dirty state is detected, without outputting the break permission signal when the clean state is detected.

15. The method according to claim 11, wherein
the condition includes detection of the clean state, and
the outputting includes outputting the break permission signal when the clean state is detected, without outputting the break permission signal when the dirty state is detected.

16. The method according to claim 10, further comprising causing the CPU core to execute the break irrespective of the result of the judgment and presence or absence of the break permission signal, when a break enable signal indicating permission of execution of the break is input to the CPU core.
